(19) United States
(12) Patent Application Publication
(10) Pub. No.: US 2020/0180536 A1
(43) Pub. Date: Jun. 11, 2020

(54) DEVICE AND AN APPARATUS FOR PROTECTING AN AUTOMOBILE UNDERSIDE

(71) Applicant: Andishe Soleimanpour, Sherman Oaks, CA (US)

(72) Inventor: Andishe Soleimanpour, Sherman Oaks, CA (US)

(21) Appl. No.: 16/788,524

(22) Filed: Feb. 12, 2020

Related U.S. Application Data
(63) Continuation of application No. 15/873,145, filed on Jan. 17, 2018.

(51) Int. Cl. B60R 19/44; C09J 7/25; C09J 7/29

(52) U.S. Cl. CPC B60R 19/445; C09J 7/25; C09J 7/29; C09J 2201/122; C09J 2201/128; C09J 2201/622; C09J 2475/006

(57) ABSTRACT

An automobile underside protector device is provided. The device may include: a flexible elongated band having a front edge and a back edge each with a height in a range from 0.12 to 0.4 inches, and a top surface and a bottom surface. Further, the juncture of the front edge and the bottom surface may have a rounded bevel.

### CROSS-REFERENCES TO RELATED APPLICATIONS

N/A.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

The present disclosure generally relates to the field of protecting automobiles from impact and, more specifically, to a device for protecting the underside of automobiles from damage.

### DESCRIPTION OF THE RELATED ART

In general, automobile drivers often encounter situations where the underside of the automobile, scrapes against a steep driveway, a speed bump, a parking block, or an uneven road surface, which can damage the automobile's bumper or rocker panels. This type of damage can be expensive to repair.

Many existing forms of automobile underside protection are custom made for specific automobiles, which can make them expensive and challenging to install. There is a need for durable and easy to install under bumper protection that can be applied to different types of automobiles.

### SUMMARY

In an embodiment, an automobile underside protector device is provided. The device may include: a flexible elongated band having a front edge and a back edge each with a height in a range from 0.12 to 0.4 inches, and a top surface and a bottom surface, wherein a juncture of the front edge and the bottom surface has a rounded bevel, wherein a juncture of the back edge and the bottom surface has a rounded bevel, and wherein the back edge has one or more notches to form teeth such that a width of the band from the front edge to an apex of each notch is in a range from 0.16 to 0.5 inches, and an adhesive applied on the top surface of the band; and wherein the protector has a u-shape notch with a bending range of 0-15 degrees to cover 75% of a standard bumper undercarriage.

In yet another embodiment, an automobile underside protector apparatus is provided. The apparatus may include: a flexible elongated band having a front edge and a back edge each with a height in a range from 0.12 to 0.4 inches, and a top surface and a bottom surface, wherein a juncture of the front edge and the bottom surface has a rounded bevel, wherein a juncture of the back edge and the bottom surface has a rounded bevel, and wherein the back edge has one or more notches to form teeth such that a width of the band from the front edge to an apex of each notch is in a range from 0.16 to 0.5 inches, and an adhesive applied on the top surface of the band; and wherein the protector has a u-shape notch with a bending range of 0-15 degrees to cover 75% of a standard bumper undercarriage.

In still another embodiment, an automobile underside protector system is provided. The system may include: a flexible elongated band having a front edge and a back edge each with a height in a range from 0.12 to 0.4 inches, and a top surface and a bottom surface, wherein a juncture of the front edge and the bottom surface has a rounded bevel, wherein a juncture of the back edge and the bottom surface has a rounded bevel, and wherein the back edge has one or more notches to form teeth such that a width of the band from the front edge to an apex of each notch is in a range from 0.16 to 0.5 inches, and an adhesive applied on the top surface of the band; and wherein the protector has an abrasion loss with in a range of 25 mm\hat{ }3 to 50 mm\hat{ }3 based on ISO 4649.

### BRIEF DESCRIPTION OF THE DRAWINGS

The present invention is described in detail below with reference to the attached drawing figures, which are incorporated by reference herein and wherein:

FIG. 1A is a schematic side view of an automobile underside impacting a roadway in accordance with an exemplary embodiment of the invention;

FIG. 1B is a schematic side view of an automobile underside impacting a parking block in accordance with another exemplary embodiment of the invention;

FIG. 2A is a schematic bottom view of an automobile underside protector in accordance with an exemplary embodiment of the invention;

FIG. 2B is a side view of the automobile underside protector of FIG. 2A in accordance with an exemplary embodiment of the invention;

FIG. 3A is a schematic perspective view showing radial bending of an automobile underside protector in accordance with an exemplary embodiment of the invention;

FIG. 3B is a schematic perspective view showing lateral bending of an automobile underside protector in accordance with an exemplary embodiment of the invention;

FIG. 4 is a schematic front view of an automobile underside protector installed on an automobile in accordance with an exemplary embodiment of the invention;

FIG. 4A is an enlarged schematic front view of an automobile underside protector installed on an automobile in accordance with an exemplary embodiment of the invention;

FIG. 5A is a schematic bottom perspective view showing application of automobile underside protectors on an automobile in accordance with an exemplary embodiment of the invention;

FIG. 5B is a schematic bottom view showing a configuration of automobile underside protectors in accordance with an exemplary embodiment of the invention; and

FIG. 6 is a schematic bottom view showing automobile underside protectors installed on an automobile in accordance with an exemplary embodiment of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning Finally, unless a claim element is defined by reciting the word “means” and a function without the recital of any structure, it is not intended that the scope of any claim element be interpreted based on the application of 35 U.S.C. § 112, sixth paragraph.

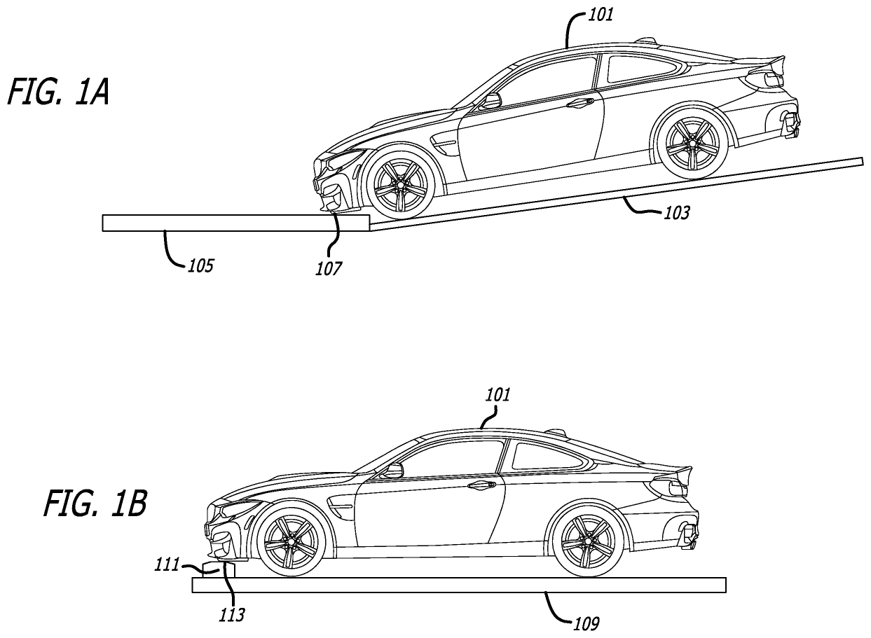

FIG. 1A illustrates a schematic side view of an automobile underside impacting a roadway in accordance with an exemplary embodiment of the invention. As shown in FIG. 1A, an underside of an automobile 101 can be damaged when a driveway 103 intersects a roadway 105 at a steep angle, rather than being level with each other. As a result of the steep angle, the underside of the automobile 101 may scrape against the roadway 105 at a point of impact 107 (e.g., an underside of the bumper), thereby causing damage to the automobile 101. This damage may include scratched paint, scuff marks, or even holes or dents. As shown in FIG. 1B, similar damage can occur when the automobile 101 is being parked in a parking lot 109 and the automobile 101 scrapes against a parking block 111 at a point of impact 113.

In an embodiment, an automobile underside protector is provided. In some embodiments, the automobile underside protector can prevent or reduce damage to an underside of an automobile. In another embodiment, the protector can be positioned on the underside of an automobile where the automobile is most likely to impact objects that will cause damage. For example, the protector can be positioned at a front edge of an underside of the bumper. If the automobile does impact an object, such as a parking block or an uneven roadway, the protector will be impacted instead of the automobile, so that the automobile is not damaged.

In some implementations, the automobile underside protector can be formed of a semi-hard, yet flexible and resilient, abrasion resistant, high tear strength material. In other embodiments, the protector can be shaped so that it can be easily formed to the underside of various different automobiles. Further, the protector can be easily applied via an adhesive on the side of the protector adjacent the automobile. In another embodiment, the protector can have rounded or beveled edges to minimize grabbing onto the object of impact.

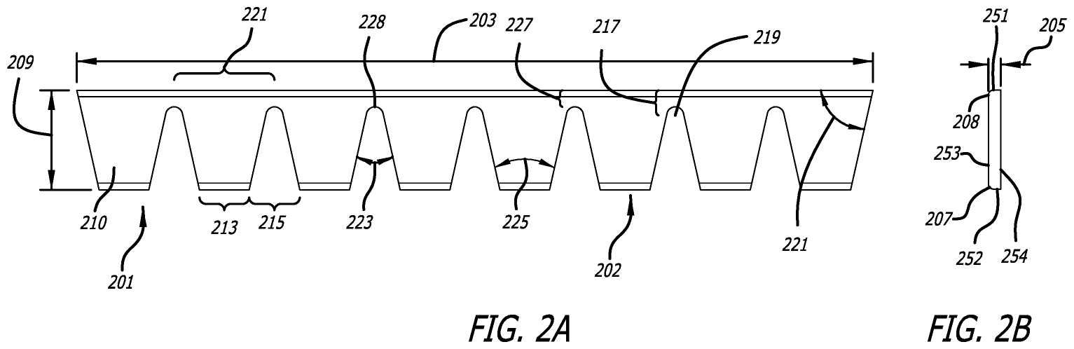

FIG. 2A and FIG. 2B illustrate various schematic views of an automobile underside protector in accordance with an exemplary embodiment of the invention. In one example, an automobile underside protector 201 for application to an underside of an automobile is shown in FIGS. 2A and 2B. The protector 201 can be applied to a bottom or underside surface of the automobile's bumper to protect the bumper from damage if the automobile scrapes against a roadway, parking block, road debris, or any other object.

In some embodiments, the hardness range may include from 70 Shore A to 95 Shore A, with a hardness of 85 Shore for optimal bending performance during an install. The protector 201 can be made using a profile extrusion method or other comparable manufacturing methods such as compression molding or mold casting. In other embodiments, the protectors may be formed from materials with hardness less than 70 Shore A, thereby resulting in insufficient protection. Alternatively, protectors formed from materials with a hardness greater than 95 Shore A resulted in non-optimal bending performance and thus difficult to perform an install.

In another embodiment, the protector 201 can be a flexible elongated band 202 formed of any suitably hard or semi-hard material, such as polyurethane or other types of flexible rubber or plastic. A suitable hardness of the material is necessary so the protector 201 is hard enough to have sufficient tear strength and abrasion resistance, but not too hard for the protector to be bent to form to the automobile during application of the protector 201.

In some embodiments, optimization may be employed. For example, this optimization may be a balance between the amount of material found between the protector's edge and a root of the notch in the protector to facilitate bending during installation. A greater amount of material may be desired to provide protection and abrasion resistance during contact between the protector and the road. However, a depth of the notch must be deep enough to facilitate bending during installation on curved surfaces on the underside of an automobile bumper. Optimizing an amount of material present versus an amount removed by the notch is desirable.

In some implementations, numerous sample protectors were tested to determine a force required to bend the protector 15 degrees and 30 degrees. Those forces were studied for significant points of inflection in the data. From the data set, it can be seen where the inflection point is most noticed. In one test, a protector with a height of 3/16 inch and a width of 1.5 inches was tested with notches of different depths. A force required to bend the protector 15 degrees and 30 degrees significantly increased when a distance between a front edge of the protector and an apex of the notch was greater than about 0.25 inches. In another test, a protector with a height of ¼ inch and a width of 1.5 inches was tested with notches of different depths. Again, a force required to bend the protector 15 degrees and 30 degrees was significantly increased when a distance between a front edge of the protector and an apex of the notch was greater than about 0.25 inches.

In some embodiments, qualitative analysis was performed to determine a desirable amount of force to bend the protector during installation, as well as protection provided when an installed protector contacted an asphalt driveway. From this testing, and the desire to have the most amount of material present in the protector as possible, it has been determined that a desirable depth from the front edge to an apex of the notch is 0.25 inches. Protectors with depths greater about 0.4 inches were difficult to install and tended become detached from the automobile. Protectors with depths less than 0.15 inches provided insufficient protection from scrapes and scratches.

In yet another embodiment, the protector can be formed of a material with an abrasion loss with in a range of 25 mm\hat{ }3 to 50 mm\hat{ }3 based on ISO 4649, and with a tear strength in a range of 40 kN/m to 85 kN/m based on DIN ISO 34-1/B/b. In some embodiments, this abrasion loss range is optimal to allow for reduced friction between the protector 201 and the road during impact. As a result, reduced friction between the protector 201 and the road allows for a longer life span of the protector 201 resulting from continuous impacts.

In still another embodiment, the protector 201 has a front edge 251, a back edge 252, a bottom surface 253, and a top surface 254. The protector 201 can be formed to have any suitable length 203, such as a length from 6 inches to 48 inches. Exemplary protectors 201 can have a height 205 of between about 0.12 and 0.4 inches. In one example, the protector 205 can have a height 205 of about 0.23 inches. Both a bevel 208 between the front edge 251 and the bottom surface 253 and a bevel 207 between the back edge 252 and the bottom surface 253 can have a radius of curvature of about 3/32 inch. The protector can have a width 209 of in a range from about 1.00 inches to 2.00 inches. For example, the protector can have a width of about 1.5 inches.

In yet another embodiment, notches can be cut in the back edge 252 of the protector 201 to form teeth 210. For example, the protector 201 can be put through a mandrel punch press to have the notches punched out. Other notch manufacturing techniques may also be used, such as die cutting, water jetting, laser cutting or the like. The notches can be u-shaped, v-shaped, s-shaped, or hexagonally shaped. A u-shaped notch, i.e., a notch with a u-shaped apex, is shown in FIG. 2A. The u-shaped notch has a radius 219 of about 0.12 inches at a distance 217 of about 0.41 inches from the front edge 251. Because of the increased flexibility of the protector 201 due to the notches, the protector 201 can be formed to fit the shape of most automobiles without the need for additional hardware. The notches allow for the protector 201 to be flexed in three-dimensions.

In an embodiment, the u-shape notch may include a bending range of 0-15 degrees that allows for optimal bending of the protector 201 to cover 75% of the surface of a standard bumper undercarriage.

In another embodiment, the v-shape notch may include a bending range of 16-30 degrees that allows for optimal bending of the protector 201 to cover 100% of the surface of a standard bumper undercarriage. In other embodiments, the v-shape notch can include a bending range greater than 30 degrees that may result in non-optimal bending. Further, the v-shape notch has the advantage of protecting the corners on the surface of the standard bumper undercarriage.

As shown in FIG. 2A, adjacent teeth 210 can have edges at an angle 223 of about 30 degrees to each other, and the edges of an individual tooth 210 can have an angle 225 of about 30 degrees to each other. An angle 221 between the inside edge of the tooth and the front edge 251 can be about 75 degrees. A length 211 of the tooth 210 towards the front edge 251 can be about 1.5 inches, and a length 213 of the tooth 210 at the back edge 252 can be about 0.65 inches. A space 215 between teeth at the back edge 252 can be about 0.9 inches.

In another embodiment, the width 227 of the protector 201 between the apex 228 of the notch and the front edge 251 can have a range from about 0.15 to 0.5 inches. In one example, the width 227 can be about 0.25 inches. Width 227 should be wide enough to provide sufficient protection for the automobile, but not so wide that the protector 201 is difficult to bend during installation. For example, this optimization may be a balance between the amount of material found between the front edge 251 and the apex 228 of the notch to facilitate bending of the protector 201 during installation. A sufficient amount of material is desired to provide the greatest protection for the automobile and abrasion resistance during contact between the protector and an object. However, the depth of the notch is adequately or sufficiently deep to facilitate bending during installation on the curved underside of automobiles.

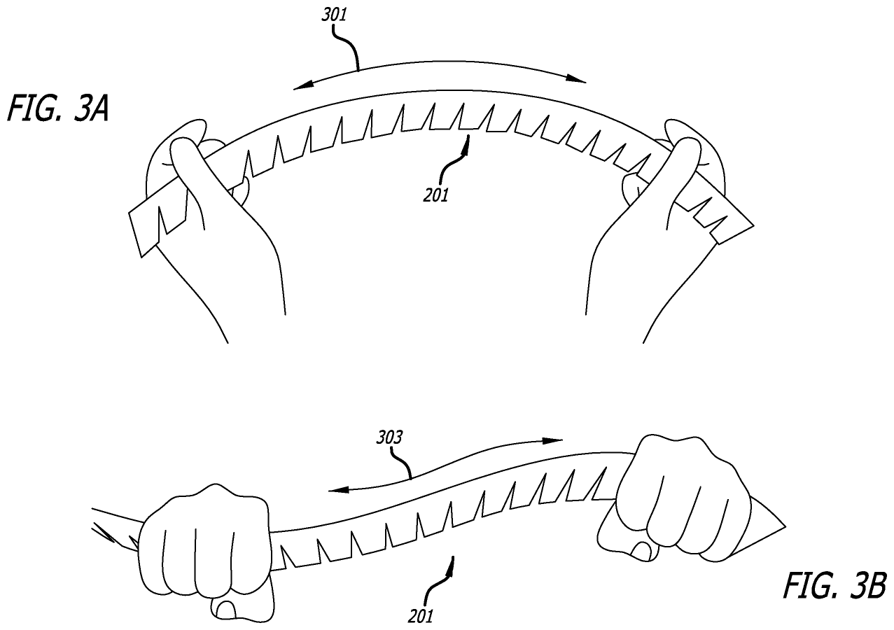

FIG. 3A and FIG. 3B illustrate various bending views of an automobile underside protector in accordance with an exemplary embodiment of the invention. As shown in FIG. 3A, because of the notches, the protector 201 can be bent radially 301. For example, the protector can be curved about an axis parallel to, and outside the plane of, the top and bottom surfaces. As shown in FIG. 3B, the protector 201 can also be bent or flexed laterally 303. For example, the protector 201 can be curved about an axis normal to the plane of the surfaces. The protector 201 can be both radially and laterally bent at the same time to achieve a multitude of shapes to accommodate application to different types of automobiles with various dimensions and curvatures.

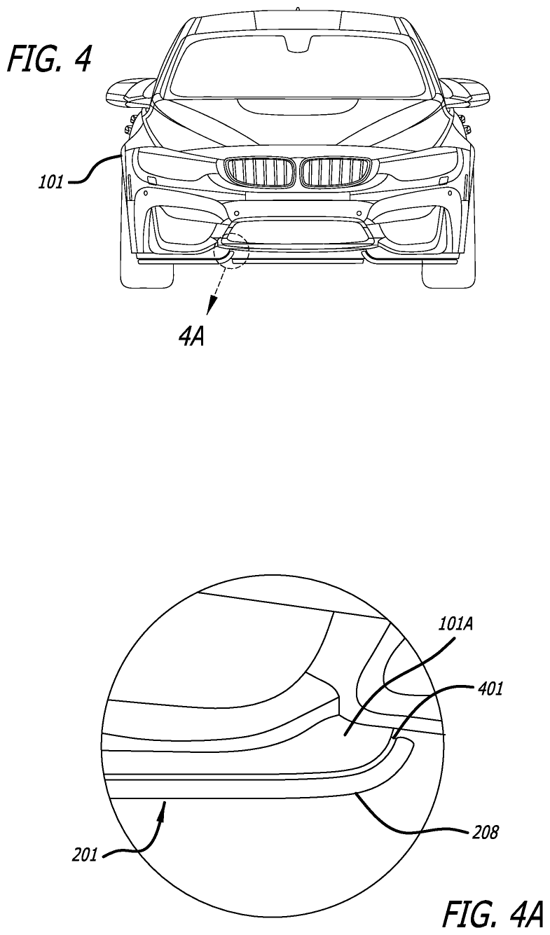

In some embodiments, the protector 201 can be installed on a bottom surface of a bumper 101A of automobile 101, as shown in FIGS. 4 and 4A. The band of semi-hard material 202, as described above, can be attached to the bumper 101A via an adhesive 401 attached to the top side 254. The adhesive 401 can be a double-sided tape adhesive, such as a double-coated acrylic foam tape designed for attachment of automotive exterior trim parts. The adhesive 401 can have a thickness between about 0.75 mm and 1.55 mm A removable liner (not shown) may be applied to an exposed side of the adhesive to protect the adhesive before the protector 201 is installed. An example of an adhesive 401 is Acrylic Plus Tape Series EX4000 manufactured by 3M™. The 3M EX4000 tape is suitable for this application due to quick bonding time in cold weather and excellent resistance to impact in cold weather. Further, the foam core provides stress relaxation when high application loads are encountered, and the tape has high adhesion performance to low energy surfaces such as urethane and scratch-resistant and mar-resistant automotive paint systems.

In an embodiment, a bond between the adhesive and the semi-hard protective material can be improved via a Corona treatment process to increase positive surface energy of the urethane material and allow for a stronger bond. Corona treatment, or air plasma, is a surface modification technique that uses a low temperature corona discharge plasma to change properties of a surface. In other embodiments, the bond between the adhesive can be improved via a flame etching treatment or a plasma treatment. After the semi-hard protective material has undergone the treatment process, the adhesive can be bonded to the corona treated surface. Further, the notches are formed in the protector 201 after the adhesive has been applied.

In some embodiments, the protector 201 may be applied to the automobile in any known manner known to those skilled in the art. For example, to apply the protector 201 to the automobile, the liner is removed, and the protector is firmly pressed against the underside of the automobile in the desired position. It can be desirable to start application of the protector from one end and press one portion at a time into position while progressing to the other end. The automobile surface can be prepared by cleaning with a mixture of 70% isopropyl alcohol (IPA) and 30% water to ensure that the surface is free of contaminants Surfaces with existing scratches can be lightly abraded using a sand paper in order to smooth the textured surface to obtain more flatness, allowing improved contact area and adhesion. Further, priming a surface using a 3M Tape Primer 94 can improve initial and long-term adhesion to both new and scratched surfaces.

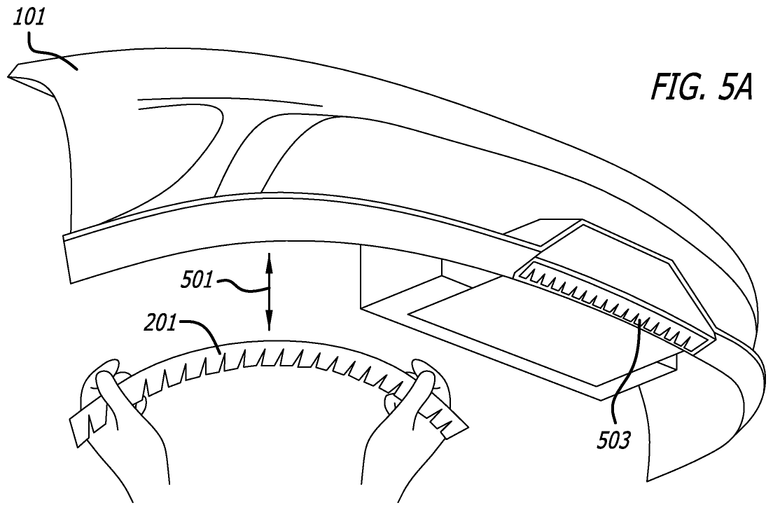

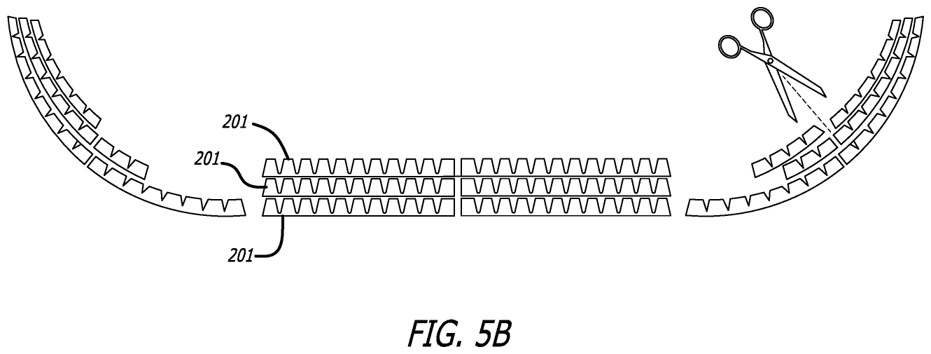

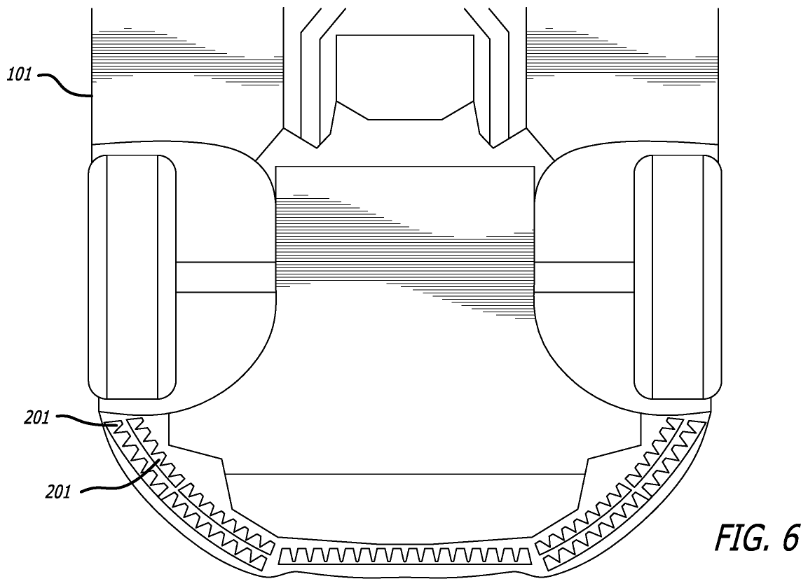

In another embodiment, the protector 201 can be bent to be applied 501 to curved portions of the underside of the automobile 101 or can be left straight to be applied 503 to straight portions of the underside of the automobile 101, as shown in FIG. 5A. Multiple protectors 201 can be applied in adjacent rows to provide protection to larger surfaces, and protectors 201 can be cut to fit, as shown in FIG. 5B. FIG. 6 shows a bottom view of an automobile 101 where multiple protectors 201 have been shaped and cut to provide protection to the bottom surface of the bumper.

In yet another embodiment, the protector can be any of one or more desired colors, such as black, white, or any color that matches a color of the automobile. The protector can also be clear or transparent. The protector can also be colors chosen as an accent or to be easily noticed by observers, such as bright or fluorescent colors. Characters, designs, or logos can also be included on any portion of the protector.

In still another embodiment, the surfaces of the protector, e.g., the front and back edges and top and bottom surfaces, can have various different textures. For example, the front edge and bottom surface can be smooth to reduce grabbing of the protector by an impacted object. The top surface can have a texture that will facilitate adherence of the adhesive.

In other embodiments, the protector can have additional layers, such as a protective coating or metal guards. The material of the protector can have inclusions, e.g., inclusions that have a different hardness from the primary material of the protector.

While the protector is described and shown as having a rectangular cross-section, the protector can have cross-sections of other shapes, such as wedge-shapes. For example, the front edge can be taller or shorter than the back edge, or the top surface can be wider or narrower than the back surface. Further, the front edge can be at an angle of less than 90 degrees to the top surface, so that the protector is less likely grab an impacted objected.

In another embodiment, the adhesive can be either a dark or black color, or a color that matches the automobile. The adhesive can also be a brighter color chosen as an accent color. The adhesive can also be clear or transparent. Although the protector is generally installed with the front edge towards the front, it can be installed in various other configurations to fit the underside of the automobile. In addition to the bumper, the protector can be installed on any desired portion of the automobile, such as under side portions of the automobile, under rocker panels, under a rear bumper, etc.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. An automobile underside protector device comprising:
a flexible elongated band having a front edge and a back edge each with a height in a range from 0.12 to 0.4 inches, and a top surface and a bottom surface, wherein a juncture of the front edge and the bottom surface has a rounded bevel, wherein a juncture of the back edge and the bottom surface has a rounded bevel, and wherein the back edge has one or more notches to form teeth such that a width of the band from the front edge to an apex of each notch is in a range from 0.16 to 0.5 inches, and an adhesive applied on the top surface of the band; and wherein the protector has a u-shape notch with a bending range of 0-15 degrees to cover 75% of a standard bumper undercarriage.

2. The device of claim 1, wherein the band is formed of polyurethane.

3. The device of claim 1, wherein a width of the teeth is greater than the width of the band from the front edge to the apex of the notch.

4. The device of claim 1, wherein the adhesive comprises double-sided tape adhesive.

5. The device of claim 1, wherein the top surface is corona treated prior to application of the adhesive.

6. The device of claim 1, wherein each of the rounded bevels has a radius of 3/32 inch.

7. The device of claim 1, wherein a width of the band is in a range from 1.00 inches to 2.00 inches.

8. The device of claim 1, wherein the apex is rounded.

9. The device of claim 1, wherein the apex has a radius in a range from 0.12 inches to 0.40 inches.

10. The device of claim 1, wherein edges of adjacent notches are at an angle to each other in a range from 20 degrees to 40 degrees range.

11. The device of claim 1, wherein the band has a hardness of 85 Shore A.

12. An automobile underside protector apparatus comprising:
a flexible elongated band having a front edge and a back edge each with a height in a range from 0.12 to 0.4 inches, and a top surface and a bottom surface, wherein a juncture of the front edge and the bottom surface has a rounded bevel, wherein a juncture of the back edge and the bottom surface has a rounded bevel, and wherein the back edge has one or more notches to form teeth such that a width of the band from the front edge to an apex of each notch is in a range from 0.16 to 0.5 inches, and an adhesive applied on the top surface of the band; and wherein the protector has a u-shape notch with a bending range of 0-15 degrees to cover 75% of a standard bumper undercarriage.

13. The apparatus of claim 12, wherein a width of the teeth is greater than a width of the band from the front edge to an apex of the notch.

14. The apparatus of claim 12, wherein the rounded bevel has a radius of 3/32 inch.

15. The apparatus of claim 12, wherein a width of the band is in a range from 1.00 inches to 2.00 inches.

16. The apparatus of claim 12, wherein an apex of each of the notches is rounded.

17. The apparatus of claim 12, wherein edges of adjacent notches are at 30 degrees to each other.

18. The apparatus of claim 12, wherein the band has a hardness of 85 Shore A.

19. The apparatus of claim 12, wherein the front edge and the back edge each have a height in a range from 0.12 and 0.4 inches.

20. The apparatus of claim 12, wherein a width of the band from the front edge to an apex of each notch is in a range from 0.15 to 0.5 inches.
